(19) United States
(12) Patent Application Publication
(10) Pub. No.: US 2010/0107849 A1
(43) Pub. Date: May 6, 2010

(54) Coated Neck Assembly For A Stringed Musical Instrument

(75) Inventor: John R. Shaffer, Reno, NV (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Optek Music Systems, Inc.

(21) Appl. No.: 12/608,220

(22) Filed: Oct. 29, 2009

Related U.S. Application Data
(60) Provisional application No. 61/110,261, filed on Oct. 31, 2008.

(51) Int. Cl. G10D 3/00; G10D 3/06; G09B 15/00; B29D 17/00

(52) U.S. Cl. 84/293; 84/314 R; 84/485 R; 29/896.22; 84/464 A

(57) ABSTRACT

Disclosed herein are various systems and methods for providing a neck assembly for a stringed instrument. The neck assembly can include a fingerboard structure having a well configured to receive a light-emitting device and permit light transmission from the light-emitting device to the top surface of the fingerboard structure, the well being located to represent a finger position of the stringed instrument. The neck assembly can further include a wooden neck structure attached to the fingerboard structure and have a lower surface substantially covered with a polymeric coating.

### TECHNICAL FIELD

The present disclosure generally relates to stringed musical instruments. More particularly, the present disclosure relates to a coating for a neck assembly of a stringed musical instrument.

### BACKGROUND

Learning to play any instrument, and particularly stringed instruments, such as, a guitar, violin, banjo and the like, can be difficult and time consuming. In general, to play such instruments, multiple strings are pressed against a fingerboard at one or more finger positions disposed along a neck of the instrument. At the same time, one or more selected strings are vibrated via plucking, strumming or bowing, producing a musical tone, note, or chord. Fingerboards on stringed instruments such as violins and cellos, do not usually indicate finger positions. Conversely, guitars, for example, do have visual indicators, known as frets, wherein the fingerboard can be called a “fretboard.”

Although proficiency with stringed instruments can be acquired using instructors, self-teaching books, or automated chord charts, these are often time-consuming and arduous methods. Typically, a student translates diagrams from paper or a computer screen to locations of finger positions along the fingerboard. Next, the student determines which strings to vibrate. Further, because a single note or cord can be played using one of several different finger positions or strings, the student must then determine which of those positions is most beneficial in a sequence of notes or chords according to a song or tune.

Some attempts have been made to facilitate the learning process. One provides a fingering display apparatus that has one or more holes bored in a fretboard. Light shines through the holes to indicate finger positions. However, the holes are difficult to create and often weaken the neck and reduce the instrument's tonal qualities. Also, the neck of the instrument may flex unnecessarily, requiring frequent adjustment. Further, the bores often require a cover, providing a visible indication that the instrument had been altered.

Thus, there is a need to provide a fingerboard for an instrument that can provide a learning tool, be inexpensive and unobtrusive, and can utilize a light-system with the fingerboard. Further, there is a need to provide such a fingerboard that does not reduce the integrity of the instrument, while providing a tactile feel similar to that of an instrument using a non-modified fingerboard.

Traditionally, fingerboards and necks of stringed instruments were made of wood, in part due to wood's superior sound qualities. However, wood is generally not suitable for constructing a fingerboard that includes a light-system. Such a fingerboard is usually constructed from a polymeric material to better accommodate the light-system. To retain a high sound quality of the stringed instrument, a polymeric fingerboard can be combined with a wooden neck. However, polymeric and wooden materials have different physical properties. Both materials can be affected differently by environmental factors, such as humidity and temperature. For example, differential expansion of wood and plastic in high or low humidity could cause relative movement between the wooden and polymeric components. Such unwanted movement could affect the tonal qualities or structural integrity of the stringed instrument. The present disclosure provides a solution to one or more of the problems outlined above.

### SUMMARY

The inventors of the present disclosure recognized that stringed instruments having a light-system are advantageous. For example, methods and apparatuses such as those described in U.S. Pat. Nos. 4,915,005 and 5,266,735, 7,173,175, 7,323,633, and 7,427,707, each of which are hereby incorporated in their entirety by reference, have been shown to be useful.

In one embodiment of the present disclosure, a neck assembly for a stringed instrument is provided. The neck assembly includes a wooden neck structure having an upper surface, a lower surface substantially covered with a polymeric coating, and a section configured to engage with a body of a stringed instrument. The neck assembly can also include a fingerboard structure having a top surface and a bottom surface, wherein the bottom surface can be attached to the upper surface of the wooden neck structure. The fingerboard structure can also include a well formed within and extending from the bottom surface toward the top surface, wherein the well can be configured to receive a light-emitting device and permit light transmission from the light-emitting device to the top surface, the well being located to represent a finger position of the stringed instrument.

Another embodiment of the present disclosure is directed to a learning tool for learning to play a stringed instrument. The tool can include a wooden neck structure having an upper surface, a lower surface substantially covered with a polymeric coating, and a section configured to engage with a body of a stringed instrument. The tool can further include a fingerboard structure having a top surface and a bottom surface, wherein the bottom surface can be attached to the upper surface of the wooden neck structure. The fingerboard structure can also include a well formed within and extending from the bottom surface toward the top surface, wherein the well can be configured to receive a light-emitting device and permit light transmission from the light-emitting device to the top surface, the well being located to represent a finger position of the stringed instrument.

Another embodiment of the present disclosure is directed toward a method for manufacturing a neck assembly, including providing a wooden neck structure having an upper surface, a lower surface, and a section configured to engage with a body of a stringed instrument. The method also includes providing a fingerboard structure having a top surface, a bottom surface, and a well formed within the fingerboard structure and extending from the bottom surface toward the top surface, wherein the well can be configured to receive a light-emitting device and permit light transmission from the light-emitting device to the top surface, the well being located to represent a finger position of the stringed instrument. Further, the method includes attaching the bottom surface of the fingerboard structure to the upper surface of the wooden neck structure, and substantially covering the lower surface of the wooden neck structure with a polymeric coating.

### BRIEF DESCRIPTION OF THE DRAWINGS

The accompanying drawings, which are incorporated in and constitute a part of this specification, illustrate several embodiments of the disclosure and together with the description, serve to explain the principles of the disclosure. In the drawings:

FIG. 1 is an embodiment of a fingerboard according to the disclosure and illustrates the structure with a plurality of wells, each extending from a bottom surface toward, but not through, a top surface.

FIG. 2 is a cross-sectional expanded view along a neck of an instrument showing a fingerboard, a circuit board and a neck base.

FIG. 3 is the cross-sectional view of the instrument neck of FIG. 2 in an assembled position.

FIG. 4 is a cross-sectional view of a fingerboard according to the disclosure having a chamfered bottom surface adapted to receive a circuit board of a light-system.

FIG. 5 is a guitar with the fingerboard of FIG. 1 mounted or otherwise attached to a neck of the guitar, together with a light-system circuit board with light-emitting devices that can illuminate certain finger positions along the fingerboard.

FIG. 6 is a side view of the guitar of FIG. 5.

### DESCRIPTION OF THE EMBODIMENTS

The present disclosure provides a neck assembly for a stringed instrument that includes a fingerboard (fretboard) configured for use with a light-system. The light-system can designate one or more finger positions by illuminating one or more positions along the fingerboard, whereby these positions can correspond to musical notes or chords. Wells located to represent finger positions can be disposed within the fingerboard. The wells can extend from openings in a bottom surface toward, but not through, a top surface of the fingerboard. Light-emitting devices of the light-system can be disposed within the wells such that they are visible from the top surface when illuminated, e.g., visible to a player of the instrument. The fingerboard can be a single-piece, opaque polycarbonate structure, manufactured using injection-molding methods. The neck assembly can further include a substantially impermeable coating to limit delamination of the neck assembly that could occur due to expansion or contraction of the wooden portion of the neck assembly.

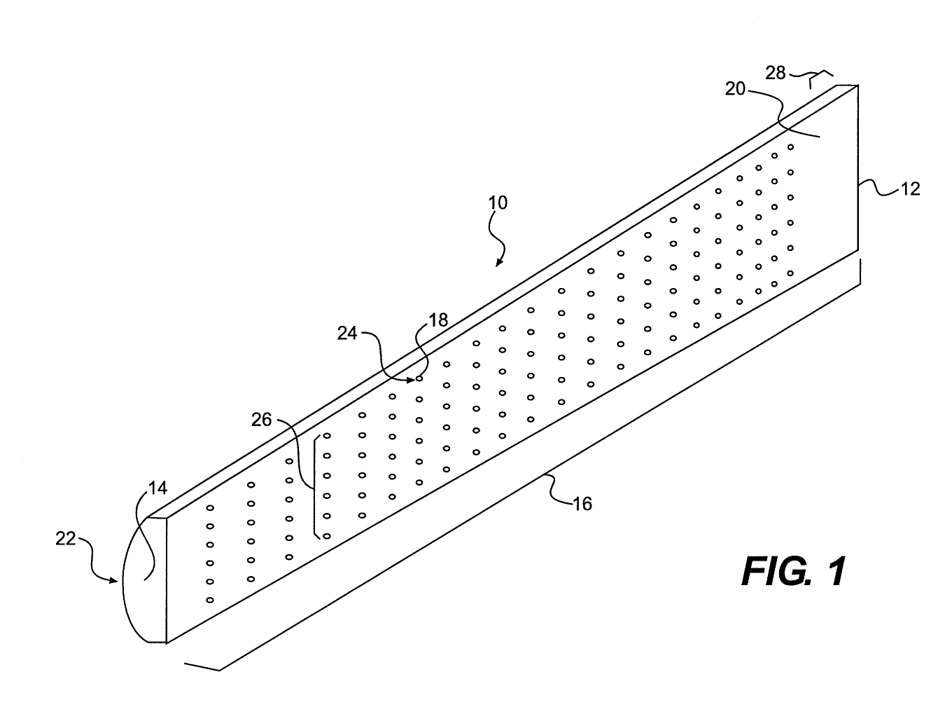

FIG. 1 shows an embodiment of a fingerboard 10 that can be used with a light-system for illuminating finger positions corresponding to notes or chords of a stringed instrument. Fingerboard 10 can be a generally elongated structure having a distal end 12, a proximal end 14, and an elongated body 16 extending between distal end 12 and proximal end 14. Fingerboard 10 can also include a top surface 22 and a bottom surface 20. Top surface 22 can be generally smooth and sufficiently hard to allow a player to press one or more strings at corresponding finger positions against it while playing the instrument. Bottom surface 20 can be generally smooth and flat, and can be adapted to receive a circuit board of a light-system or a portion of neck assembly 200 as discussed below.

Openings 24 are disposed along bottom surface 20 of fingerboard 10, and can have a respective well 18 that extends from bottom surface 20 toward, but not through, top surface 22. Wells 18 may be sized to receive a light-emitting device (e.g., LED) of the light-system. Wells 18 may be configured to permit light transmitted from the light-emitting device to pass through top surface 22.

In some embodiments, top surface 22 can be generally convex in shape. In other embodiments top surface 22 can be flat, triangular, rounded, or have a shape including components of one or all of the basic shapes. Top surface 22 can provide a surface upon which strings of the instrument can be pressed during use of the instrument, such that the player can easily move between finger positions. Top surface 22 may be generally sanded or otherwise smooth, and can have decorations, inlays or other insignia.

In one embodiment, top surface 22 can be adapted to provide or receive one or more frets. These frets can include fret bars that can be visually indicated through use of inlays, printing, insignia, or decorative designs. Frets can be a different material than fingerboard 10 and can include a raised structure oriented generally transverse to the elongated axis of fingerboard 10. Further, top surface 22 can have grooves or fret-slots to receive the frets, or can be adapted to receive frets having nut-assemblies to secure them to the fingerboard 10. Also, frets may be adhered directly on top surface 22 of fingerboard 10 when fret-slots are not present.

Fret-migration, where shrinkage of a fingerboard causes frets to extend beyond its edges, can be reduced by selecting materials having similar coefficients of expansion. In particular, the materials of both fingerboard 10 and the frets can be suitably matched. For example, polymer materials can be used to manufacture fingerboard 10.

Fingerboard 10 may be adapted for instruments that are “fret-less,” such as, for example, a violin. Fingerboard 10 can also be suitable for instruments that have frets, such as, for example, a guitar. Use of the terms “fretboard” and “fingerboard” are encompassed within the present disclosure, and the terms “fretboard” and “fingerboard” are used interchangeably herein.

Top surface 22 should be sufficiently smooth to allow a player to quickly and easily slide their hand along top surface 22 and neck of the instrument to a next finger position. Top surface 22 can also be sufficiently hard to allow the player to press one or more strings against it while playing the instrument. Fingerboard 10 can have a top surface 22 that is similar to the color, shape, and size of one that would be commonly used on the intended instrument. Some players may also prefer unusually colored, shaped or sized fingerboards, and those can also be accomplished by the present disclosure.

In general, bottom surface 20 can be flat and smooth. Bottom surface 20 may also be adapted to receive or otherwise couple with a circuit board of the light-system, wherein the light-system may utilize a circuit-board. Also, bottom surface 20 can be mounted on, or attached to, the neck of the instrument, as discussed below. In some instances, bottom surface 20 can be disposed on or attached to an upper surface of a neck of the instrument. Further, bottom surface 20 can be glued, screwed, bolted, or otherwise attached, either permanently or releasably, to another component of the stringed instrument.

In some embodiments, openings 24 can be disposed on or along bottom surface 20. Generally, openings 24 can be positioned beneath appropriate finger positions or other positions on the top surface 22 associated with notes or chords of the instrument. Also, openings 24 can be organized into rows 26 that correspond to a fret position such as a fret bar, where a fret position can have multiple finger positions at the same location along the length of top surface 22. For example, row 26 can correspond to a fret position number four, as known in the art. Thus, row 26 can have the same number of openings as the instrument has number of strings, e.g., a six-string guitar can have rows of six wells 18.

Well 18 can extend from a respective opening 24 in a direction toward top surface 22, but does not generally extend through top surface 22. Each opening 24 can have a respective well 18, and each well 18 can correspond to a finger position. Other positions can also have a corresponding well, such as, for example, a bridge location 28 located near the distal end 12, when the instrument includes a bridge. Because the wells do not generally extend through the top surface, caps or well-covers are not required, and top surface 22 will appear generally unaltered. Thus, a viewer of the instrument cannot easily detect the embedded light-system when the light-emitting devices are not illuminated.

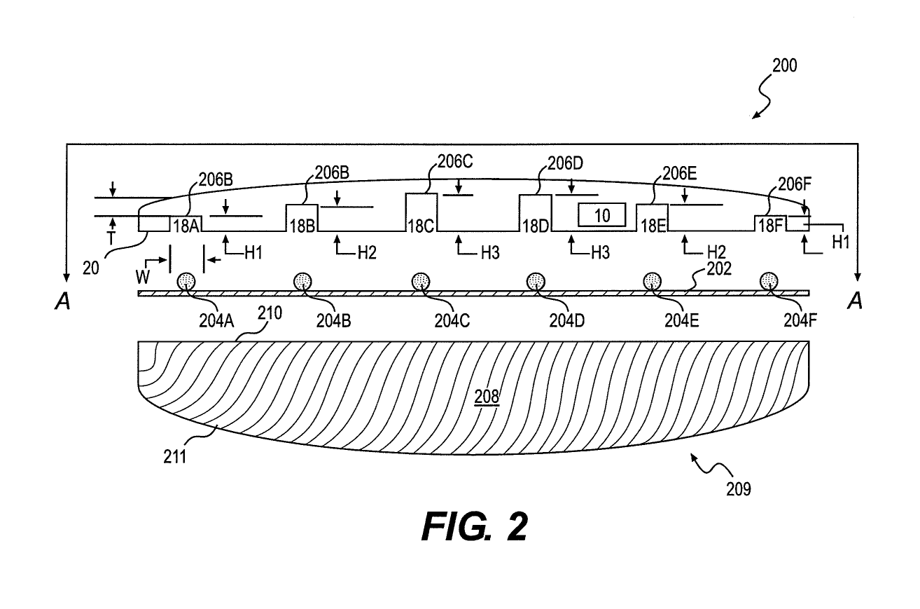

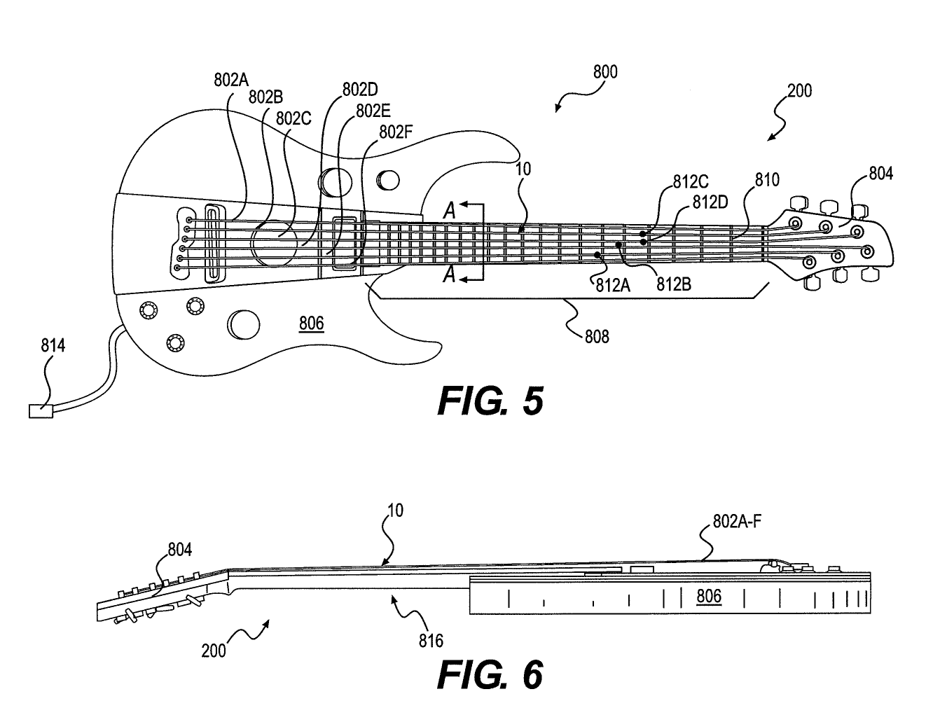

FIG. 2 illustrates a cross-sectional expanded view of a neck assembly 200 across a transverse axis A of a stringed instrument 800 (FIG. 5). In some embodiments, neck assembly 200 can include fingerboard 10, one or more light-emitting devices 204 and a neck base 208. FIG. 2 also shows a circuit board 202 having multiple light-emitting devices 204. Neck base 208 may be wood and may include an upper surface 210 and a lower surface 211. Fingerboard 10 may be a polymeric material and may include one or more wells 18. Wells 18 may extend from bottom surface 20 toward, but not through, top surface 22. As shown, top surface 22 includes a convex shape, which can be advantageous for certain instruments.

To conform with the convex top surface 22, wells 18 can have differing heights H1-H6 depending on the well's transverse location across fingerboard 10. In particular, each well can have a height such that a thickness T of material between a well-top 206 and top surface 22 is approximately constant. Such a configuration can permit illuminating light-emitting devices to emit similar intensity from top surface 22.

The height of each well should be sufficiently large to allow an illuminated light-emitting device disposed within well 18 to be visible when viewed from top surface 22 of the fingerboard. Also, the thickness of material between well 18 and top surface 22 should be sufficiently large to provide a stable surface against which a string may be pressed while playing the instrument. In some embodiments, the thickness of material may be about 0.01 inch to 0.4 inch, and in other embodiments about 0.05 inch and 0.1 inch.

Further embodiments of fingerboards according to the present disclosure are also possible. Fingerboards made of different materials may also require different thicknesses of material between the top of wells 18 and top surface 22. Also, the height of wells 18 can be approximately equal, the wells can have rounded or convex tops, or the wells can be slanted or angled. Thus, various well shapes, sizes, or geometries, can be utilized.

Wells 18 can be sized to receive light-emitting devices 204 disposed on or connected to circuit board 202. Each light-emitting device 204 may be positioned along circuit board 202 at a position corresponding to a single well 18. In some embodiments, a light-system may not utilize a circuit board. Rather, electrical lands, connectors, decoders, or other electronic devices may operate with fingerboard 10. For example, conducting electrical lands can be transferred, etched or otherwise disposed on bottom surface 20 or through fingerboard 10. In such embodiments, bottom surface 20 can mate directly to neck base 208, rather than as in the illustrated embodiment where circuit board 202 is located between bottom surface 20 and neck base 208. Exemplary light-system are described in U.S. Pat. Nos. 4,915,005 and 5,266,735.

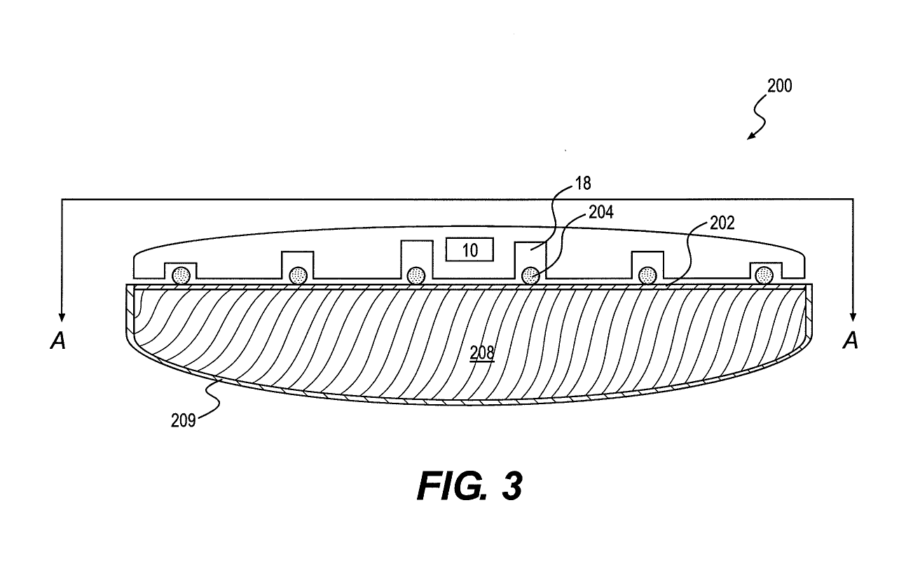

FIG. 3 shows the elements of FIG. 2 in an assembled formation. As shown, neck assembly 200 includes fingerboard 10 with a plurality of wells 18, wherein each well 18 has a light-emitting device 204 disposed therein. Fingerboard 10 is shown coupled to circuit board 202, which is also coupled to neck base 208. Such neck assemblies can offer advantages over traditional designs. For example, neck assembly 200 as shown can have improved strength and the polymer fingerboard may improve tonal qualities of the instrument.

Fingerboard 10, circuit board 202 and neck base 208 can be assembled using a variety of techniques. For example, adhesives or glues can be used for permanent bonding. Fingerboard 10 should be held securely to neck base 208 in order to avoid movement between the two, as such movement could degrade the usability of the instrument, causing delamination. Such delamination can affect the tonal qualities of the instrument and may render the instrument unplayable. In embodiments where disassembly may be desired, other attachment systems such as screws, nut assemblies, snap fittings and/or other releasable connections can be used to connect fingerboard 10, circuit board 202, or neck base 208.

Fingerboard 10 can include a single piece of injection molded polymer material. The mold could provide a plurality of wells extending from a bottom surface of the fingerboard toward, but not through, a top surface. Each well may be sized to receive a light-emitting device of a light system. In some embodiments, the fingerboard can be at least partially manufactured of a polycarbonate material.

Also, fingerboards described herein can be constructed to provide an altered-appearance. For example, a fingerboard can be made of opaque or translucent material. Fingerboards made from polycarbonate materials can be injection molded or colored as required. In other embodiments, blinking lights or exposed circuitry can be displayed if the fingerboard material is clear or slightly tinted. Plexiglas®, plastics or other polymeric materials can be used to form part of a fingerboard.

Various other manufacturing processes can also be used. The openings and wells can be created with or after manufacturing of the fingerboard structure, using techniques, such as, for example, drills, presses, templates, etc. As noted above, fret-slots can be cut, or can be integrated into an injection molding process.

In some embodiments, neck base 208 may be coated with a coating 209. Coating 209 can include a polymer configured to reduce the affect of environmental factors on neck base 208. For example, wood can expand or contract with changes in humidity, temperature, pressure, or other environmental factors. A substantially impermeable coating can reduce the effects of these changes on a wooden neck.

By way of example, neck base 208 could be coated with a polyester material. The polyester material could be sprayed onto neck base 208 to form coating 209 of suitable thickness to substantially reduce changes in wood volume caused by changes in environmental factors. Other polymeric materials could include resins, silicone, polyamides, polyethylene, or other suitable polymers.

Various polymeric materials may be selected based on their physical properties, including impermeability, hardness, ductility, curing temperature, or surface texture when cured. The polymers may be applied by spraying, dipping, or other suitable deposition techniques. Also, certain polymers may require the application of one or more layers of primer before application of the polymeric material. Further, neck base 208 may require sanding or some other surface treatment or processing before application of coating 209. Also, one or more applications of one or more polymeric materials may be required to form coating 209. For example, neck 208 may require sanding before application of a first coating. After curing the first coating, a second coating may be applied. Various treatments, such as, for example, sanding, curing, or priming the various coatings, may also be required.

Coating 209 can be applied to one or more surfaces of neck base 208. For example, as shown in FIGS. 2 and 3, coating 209 can be applied to lower surface 211 of neck base 208. Coating 209 may also be applied to one or more side surfaces of neck base 208. In some embodiments, coating 209 may not be applied to upper surface 210 as fingerboard 10 or circuit board 202 may provide a sufficient barrier to the changes in environmental factors. In other embodiments, coating 209 can be applied to upper surface 210.

Coating 209 may be applied to one or more sides of neck base 208 before or after fingerboard 10 or circuit board 202 has been attached to neck base 208. In particular, coating 209 may be applied to lower surface 211 of neck base 208. Then, fingerboard 10 or circuit board 202 may be applied to upper surface 210 of neck base 208. Conversely, coating 209 may be applied after bonding fingerboard 10 or circuit board 202 with neck base 208.

Fingerboard 10 can also be manufactured with a width slightly wider than the width of neck base 208. Following assembly, the side edges of fingerboard 10 can be ground, sanded, or otherwise shaped to produce smooth adjoining edges and remove any excess adhesive when attachment such methods are used. Various other finishing techniques could also be applied.

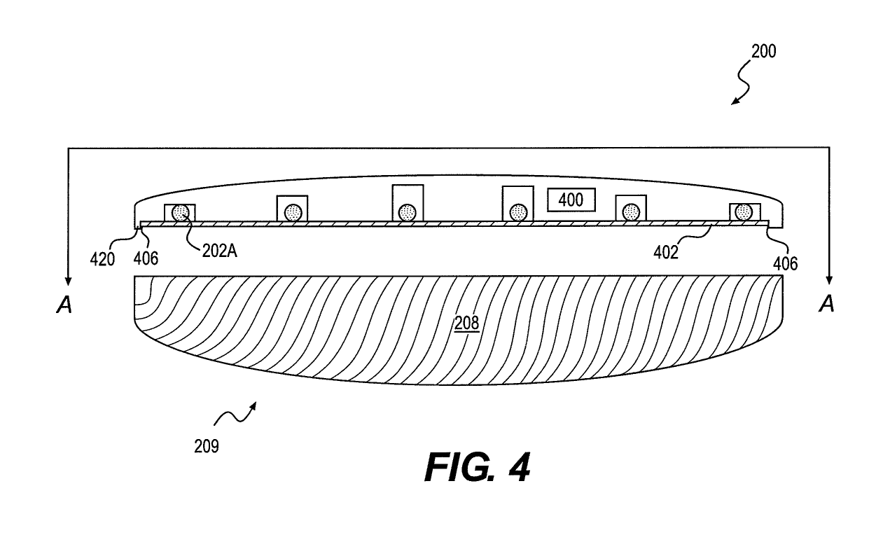

In some embodiments, fingerboard 10 may be configured to include a chamfered or otherwise recessed area on one or more surfaces. For example, FIG. 4 shows a fingerboard 400 including a bottom surface 420 having a recessed area 406 sized to receive a circuit board 402, sized to fit within recessed area 406. Such an assembled configuration can at least partially conceal circuit board 402 when viewing the instrument from a side angle. For example, neck assembly 200 may not appear laminated when assembled.

FIGS. 5 and 6 show an example of neck assembly 200 as part of a guitar, wherein instrument 800 generally has multiple frets 810, and six or more strings 802. By way of background, strings 802 (A-F) are usually tensioned between a head 804 and a body 806 and at least partially extend along a neck 808 such that each string produces a different note when vibrated. Pressing one or more strings 802 against the top surface of the fingerboard 10 at various finger positions, and then vibrating one or more strings, produces a musical note or chord.

Light-emitting devices can be selectively illuminated to display a desired note or chord on fingerboard 10. Select light-emitting devices can be illuminated and their light visible to a player of the guitar. The player could press strings designated by each of those illuminated devices 812 (A-D) to play the desired note or chord. As illustrated, string 802B could be pressed at finger position 812C, string 802C could be pressed at finger position 812C, string 802C could be pressed at finger position 812B, and string 802D could be pressed at finger position 812A.

In some embodiments, a connector 814 could be used to couple the circuit board of light-system to a controller, such as, for example, a computer, portable electronic device, or other control processor. In other embodiments, a light-system could be coupled to a processor using wire-less technologies, such as, for example, 801.11a, 801.11.g, or blue-tooth. Various protocols can be utilized to provide communication between the light-emitting devices and a processor or computer system.

Other embodiments of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

What is claimed is:

1. A neck assembly for a stringed instrument, comprising:
a wooden neck structure having an upper surface, a lower surface substantially covered with a polymeric coating, and a section configured to engage with a body of a stringed instrument;
a fingerboard structure having a top surface and a bottom surface, wherein the bottom surface is attached to the upper surface of the wooden neck structure; and
at least one well formed within the fingerboard structure and extending from the bottom surface toward the top surface, wherein the well is shaped and sized to receive a light-emitting device and permit light transmission from the light-emitting device to the top surface, the well being located to represent a finger position of the stringed instrument.

2. The neck assembly of claim 1, further including a circuit board having a plurality of light-emitting devices and at least partially located between the wooden neck structure and the fingerboard structure.

3. The neck assembly of claim 2, wherein at least one of the wooden neck structure and the fingerboard structure further includes a recessed area configured to receive the circuit board.

4. The neck assembly of claim 1, further including a plurality of frets disposed along the top surface of the fingerboard structure.

5. The neck assembly of claim 1, wherein the fingerboard structure includes a polymer material.

6. The neck assembly of claim 1, wherein the upper surface of the wooden neck structure includes a polymeric coating.

7. The neck assembly of claim 1, wherein the polymeric coating includes a polyester material.

8. The neck assembly of claim 1, wherein a thickness of material between a top of the well and the top surface is between approximately 0.01 inches and approximately 0.4 inches.

9. The neck assembly of claim 1, wherein a thickness of material between a top of the well and the top surface is between approximately 0.05 inches and approximately 0.1 inches.

10. A learning tool for learning to play a stringed instrument, comprising:
a wooden neck structure having an upper surface, a lower surface substantially covered with a polymeric coating, and a section configured to engage with a body of a stringed instrument;
a light-emitting device configured to emit light;
a fingerboard structure having a top surface and a bottom surface, wherein the bottom surface is attached to the upper surface of the wooden neck structure; and
at least one well formed within the fingerboard structure and extending from the bottom surface toward the top surface, wherein the well is configured to receive the light-emitting device and permit light transmission from the light-emitting device to the top surface, the well being located to represent a finger position of the stringed instrument.

11. The learning tool of claim 10, further including a circuit board having a plurality of light-emitting devices and at least partially located between the wooden neck structure and the fingerboard structure.

12. The learning tool of claim 11, wherein at least one of the wooden neck structure and the fingerboard structure further includes a recessed area configured to receive the circuit board.

13. The learning tool of claim 10, further including a plurality of frets disposed along the top surface of the fingerboard structure.

14. The learning tool of claim 10, wherein the fingerboard structure includes a polymer material.

15. The learning tool of claim 10, wherein the upper surface of the wooden neck structure includes a polymeric coating.

16. The learning tool of claim 10, wherein the polymeric coating includes a polyester material.

17. The learning tool of claim 10, further including a processor configured to selectively illuminate the light-emitting device.

18. A method of manufacturing a neck assembly, comprising:
providing a wooden neck structure having an upper surface, a lower surface, and a section configured to engage with a body of a stringed instrument;
providing a fingerboard structure having a top surface, a bottom surface, and a well formed within the fingerboard structure and extending from the bottom surface toward the top surface, wherein the well is shaped and sized to receive a light-emitting device and permit light transmission from the light-emitting device to the top surface, the well being located to represent a finger position of the stringed instrument;
attaching the bottom surface of the fingerboard structure to the upper surface of the wooden neck structure; and
substantially covering the lower surface of the wooden neck structure with a polymeric coating.

19. The method of claim 16, further providing a circuit board having a plurality of light-emitting devices and at least partially locating the circuit board between the wooden neck structure and the fingerboard structure.

20. The method of claim 17, wherein at least one of the wooden neck structure and the fingerboard structure further include a recessed area configured to receive the circuit board.

21. The method of claim 16, wherein the fingerboard structure further includes a plurality of frets disposed along the top surface.

22. The method of claim 16, wherein the fingerboard structure is formed in part from a polymer material.

23. The method of claim 16, further including substantially covering the upper surface of the wooden neck structure with a polymeric coating.

24. The method of claim 16, wherein the polymeric coating includes a polyester material.
